(19) United States
(12) Patent Application Publication
(10) Pub. No.: US 2013/0007240 A1
(43) Pub. Date: Jan. 3, 2013

(54) SYSTEMS AND METHODS TO PROVIDE AVAILABILITY NOTIFICATIONS FOR DENIED CONTENT REQUESTS

(75) Inventors: Chaoxin Qiu, Austin, TX (US); James Jackson, Austin, TX (US); Mehrad Yasrebi, Austin, TX (US)

(73) Assignee: AT&T INTELLECTUAL PROPERTY I, L.P., Atlanta, GA (US)

(21) Appl. No.: 13/174,142

(22) Filed: Jun. 30, 2011

(51) Int. Cl. G06F 15/173

(52) U.S. Cl. 709/223

(57) ABSTRACT

A method includes receiving a message at a server. The message indicates that a network is unable to fulfill a request for media content for a user device. The method may also include sending, from the server to the user device, an offer to inform the user device when the network is able to fulfill the request.

### FIELD OF THE DISCLOSURE

The present disclosure relates generally to providing availability notifications for denied content requests.

### BACKGROUND

Significant growth of data traffic in mobile networks is occurring. As the number of customers of the mobile network increases and more mobile content services become available to the customers, there is a need for increased bandwidth capacity to service the increased demand. In certain circumstances, bandwidth capacity limits may be reached in dense usage areas (e.g., at convention centers, at stadiums, and in densely populated regions) even when the bandwidth capacity of a mobile network is generally sufficient. When bandwidth capacity limits are reached, certain services may become unavailable to some users.

### BRIEF DESCRIPTION OF THE DRAWINGS

FIG. 1 is a block diagram of a particular embodiment of a system to provide availability notifications for denied content requests.

FIG. 2 is a flow chart of a first particular embodiment of a method to provide availability notifications for denied content requests.

FIG. 3 is a flow chart of a second particular embodiment of a method to provide availability notifications for denied content requests.

FIG. 4 is a flow chart of a third particular embodiment of a method to provide availability notifications for denied content requests.

FIG. 5 is a flow chart of a fourth particular embodiment of a method to provide availability notifications for denied content requests.

FIG. 6 is a block diagram of a second embodiment of a system to provide availability notifications for denied content requests.

FIG. 7 is a continuation of the second embodiment of the system to provide availability notifications for denied content requests.

FIG. 8 is a block diagram of an illustrative embodiment of a general computer system.

### DETAILED DESCRIPTION

Users of a network (e.g., a mobile device user of a wireless communication network) may be denied access to requested media content due to insufficient network resources (e.g., network devices and bandwidth) or other constraints (e.g., the requested media content is temporarily unavailable from a content provider). A denial of access to requested media content may confuse the user, be inconvenient for the user, decrease satisfaction of the user with a network service provider, or combinations thereof. To alleviate problems associated with denying access to requested media content, the network may provide a service that allows the user to choose to receive a notification of when the network is able to provide the requested media content. Also, the service may provide the user with an option to record the requested media content to a network recorder. For example, the user of a user device may request to view a World Cup soccer match. When network resources to provide the match to the user are not available, an application on the user device may provide the user with a first option to be provided with a notification that informs the user when the match can be provided to the user of the user device, a second option to make a recording of the match at a network recorder and receive a notification that informs the user when the user is able to retrieve the recording to the user device, and a third option to record the match to the network recorder without receiving a notification of when the recording can be provided to the user device. The location of the recorded content (e.g., a uniform resource identifier for the recorded content) may be provided to the user via a message (e.g., an e-mail or a text message) or can be made accessible via a service portal for an account associated with the used device. Providing the service may alleviate potential user disappointment due to not immediately receiving the requested media content.

In a particular embodiment, a method includes receiving a message at a server. The message indicates that a network is unable to fulfill a request for media content for a user device. The method may also include sending, from the server to the user device, an offer to inform the user device when the network is able to fulfill the request.

In a particular embodiment, a system includes a processor and a memory accessible to the processor. The memory includes instructions executable by the processor to receive a request to enable a notification to a user device when a network is unable to provide media content to the user device. The memory includes instructions executable by the processor to determine whether the network is able to provide the media content to the user device. The memory also includes instructions executable by the processor to send a notification indicating availability of the media content to the user device in response to a determination by the processor that the network is able to provide the media content to the user device.

In a particular embodiment, a tangible computer-readable medium includes instructions that are executable by a processor. The instructions are executable by the processor to receive a request for media content from a user device. The instructions are executable by the processor to determine that a network is unable to provide the media content to the user device. The instructions are also executable by the processor to send selectable options to the user device. The selectable options include an option to notify the user device when the network is able to fulfill the request.

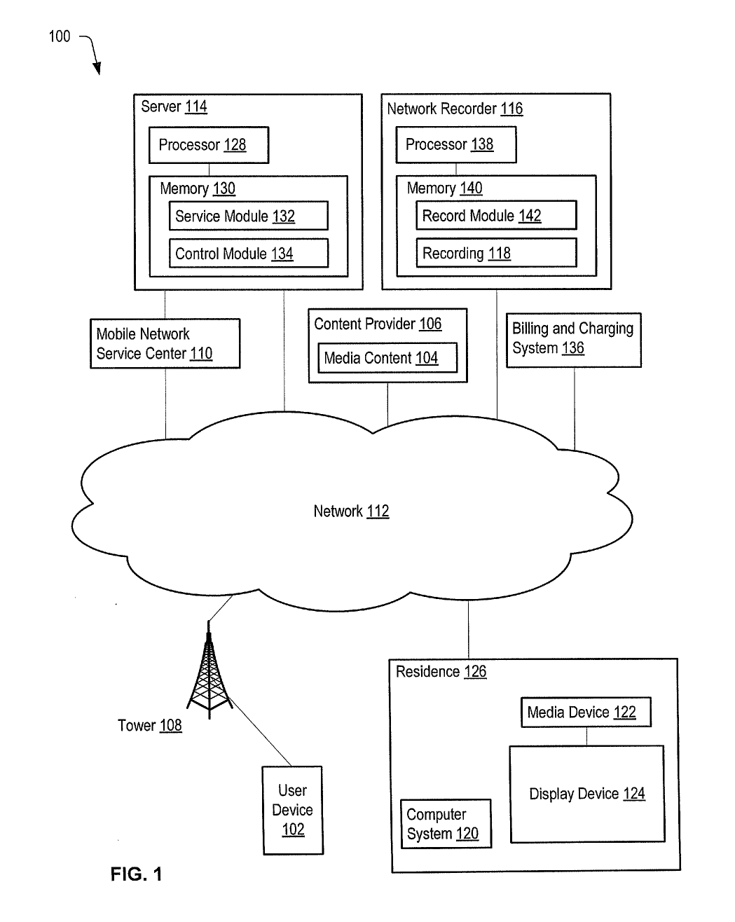

FIG. 1 is a block diagram of a particular embodiment of a system 100 to provide availability notifications for denied content requests. A user of a user device 102 may request media content 104 from a content provider 106 via the user device 102. The user device 102 may be a mobile communication device. The mobile communication device may be a mobile phone, a tablet computer, a laptop computer, a computer system, a personal digital assistant, another communication device, or a combination thereof. The media content 104 may include a live event, a recording, or other media content. The live event may include, but is not limited to, a football game, a basketball game, a soccer game, a television broadcasting program, another type of sporting event, an inauguration, a concert, coverage of an emergency, or other multimedia content.

The request may be sent from the user device 102 to a tower 108. The tower 108 may send the request to a mobile network service center 110 (e.g., a mobile switching center, servers for mobility data services, etc.) via a network 112. The mobile network service center 110 may determine whether network resources (e.g., network server capacity and access network bandwidth) are available to fulfill the request to provide the media content 104 to the user device 102 and whether other constraints inhibit delivery of the media content 104 to the user device (e.g., temporary unavailability of the media content 104 from the content provider 106). When the mobile network service center 110 determines that the network 112 is able to provide the media content 104 to the user device 102, the mobile network service center 110 may facilitate providing the media content 104 to the user device 102. For example, the mobile network service center 110 may setup a connection between the user device 102 and the content provider 106 so that the user device is able to receive the media content 104 via the network 112.

When the mobile network service center 110 determines that the network is unable to provide the media content 104 to the user device 102, the mobile network service center 110 may send a message to a server 114. The message may identify the user device 102 and the media content 104. The message may indicate to the server 114 that the request to provide the media content 104 to the user device 102 could not be fulfilled.

The server 114 may communicate with the user device 102 via the network 112. The server 114 may determine whether the user of the user device 102 wants to receive a notification of when the media content 104 is available to the user device 102 via the network 112. When the user of the user device 102 wants to receive the notification of availability of the media content 104 via the network 112, the server 114 may execute instructions that enable the server 114 to provide the notification to the user device 102, or the server 114 may send a notification request to another device with the capability to provide the notification to the user device 102. The resulting notification may be sent only when a determination is made that the network 112 is able to provide the media content 104 to the user device 102.

The server 114 may also determine whether the user of the user device 102 wants to record the media content 104 to a network recorder 116. The network recorder 116 may be a network digital video recorder. A recording 118 of the media content 104 made by the network recorder 116 at the request of the user may be saved by the network recorder 116 for a period of time. The recording 118 may be accessed by the user device 102, by one or more other devices associated with the user or the user device 102, or combinations thereof. The user device 102 may be associated with an account. The one or more other devices may also be associated with the account. For example, the account associated with the user device 102 may also be associated with a computer system 120 and a media device 122 (e.g., a set-top box device) coupled to a display device 124 at a residence 126. During the period of time, the recording 118 may be accessed at the network recorder 116 by one or more people associated with the account via the user device 102, via the computer system 120, via the media device 122, or via another device associated with the account. The network recorder 116 may implement an authentication, authorization, and accounting process to authenticate a user or device accessing the recording 118. After the period of time, the recording 118 may be deleted. Notification of the deletion may be sent to the user device 102, the one or more other devices associated with the account, one or more network devices, or combinations thereof, so that an identifier of the recording 118 will not be displayed in listings of available media content associated with the account.

The user of the user device 102 may choose to have the media content 104 recorded without receiving the notification of when the user device 102 is able to receive the recording 118 via the network 112, or the user of the user device 102 may choose to have the media content 104 recorded and receive the notification of when the user device 102 is able to receive the recording 118 via the network 112. When the user of the user device 102 chooses to have the media content 104 recorded without receiving the notification of when the user device 102 is able to receive the recording 118 via the network, an e-mail message or other notice may be sent from the server 114 to an account associated with the user device 102, the media content 104 may be presented in listings of available content shown on the user device 102 and devices associated with the user device 102 (e.g., the computer system 120 and the display device in association with the media device 122), or both. The e-mail message or notice may inform the user of the availability of the recording 118 and a duration of the availability of the recording 118. In another example, the server 114 may respond to the request from the user by sending a message to the user device. The message may indentify a network location (e.g., a uniform resource identifier) at which the user can access the recording 118 at a later time either via the user device or via another device.

When the user of the user device 102 chooses to record the media content 104 and to receive the notification, the notification may connect the user device 102 to the recording 118 after the determination that the network 112 is able to send the recording 118 to the user device 102 is made. For example, the server 114 may initiate setup of a connection between the user device 102 and the network recorder 116 via the mobile network service center 110 after the server 114 determines that the network 112 is able to send the recording to the user device 102. The network recorder 116 may stream the recording 118 to the user device 102 when the connection is established. Alternately, the notification may enable the user device to access the recording after the determination that the network 112 is able to send the recording 118 to the user device 102 is made. For example, the notification may include a location of the recording. In response to receiving the notification, the user device 102 may generate an alert (e.g., a noise) to gain the attention of the user and may present a selectable option to retrieve the recording 118. The notification to the user device 102 from the server 114 may be a short message service (SMS) message, a multimedia messaging service (MMS) message, an electronic mail message, another data communication message, or any combination thereof. When the user chooses the selectable option, the user device 102 may establish a connection to the network recorder 116 via the tower 108 and the mobile network service center 110, and the network recorder 116 may stream the recording to the user device 102. Accessing the recording 118 in response to the notification allows the user of the user device 102 to receive the media content beginning from a location of the media content 104 that is close to the portion of the media content that was being presented when the user initially requested the media content 104. The user may use controls of the user device 102 to fast forward, rewind, pause, and play the recording 118.

When the notification is provided to the user device 102 while the media content 104 is being recorded by the network recorder 116, the recording 118 may be streamed to the user device 102 while the network recorder 116 continues to make the recording 118. The user of the user device 102 may choose to stop receiving the recording 118 at the user device 102. In an embodiment, the network recorder 116 may automatically receive a command to stop making the recording 118 when the user of the user device 102 chooses to stop viewing the recording 118.

In another embodiment, the user of the user device 102 may be presented with an option to continue making the recording 118 and an option to end making the recording 118 in response to the user choosing to stop receiving the recording 118 at the user device 102. The options may be sent to the user device 102 via a network device (e.g., the server 114) or the options may be produced by the user device 102 as the result of instructions executed by a processor of the user device 102. The instructions may be a portion of an application resident in a memory of the user device 102. When the user selects to end making the recording 118, an instruction may be sent to the network recorder 116 to stop making the recording 118. The network recorder 116 may delete the recording 118. Should the connection between the user device 102 and the recording 118 be dropped while the user is receiving the recording 118, the server 114, the user device 102, or both may facilitate another connection between the user device 102 and the recording 118. For example, the network recorder 116 may send a message (e.g., an e-mail or other type of message) to the account associated with the user device 102 or to the user device 102 in response to the connection between the network recorder 116 and the user device 102 being dropped. The message may include a selectable link that facilitates reconnection of the user device 102 to the network recorder 116.

The server 114 may include a processor 128 and a memory 130 accessible by the processor 128. The memory 130 may include instructions executable by the processor 128. A portion of the instructions may be included in a service module 132 and a control module 134. The service module 132 may be activated by the processor 128 when the processor 128 receives the message from the mobile network service center 110 indicating that the user device 102 is denied access to the media content 104. The service module 132 may enable communication between the server 114 and the user device 102. The service module 132 may determine what options are selected by the user of the user device 102 with respect to the user device 102 receiving the notification of availability of the media content 104 or the recording and with respect to making the recording 118. When the user chooses to make the recording 118, the service module 132 may provide the network recorder 116 with information that enables the network recorder 116 to make the recording 118. For example, the information may include a program channel, a content source uniform resource identifier, or other identifier of the media content 104. The network recorder 116 may provide the service module 132 with information specifying a location of the recording 118. The service module 132 may send the information specifying the location of the recording 118 to a network device that enables the user device 102, the one or more other devices associated with the user device 102, or both, to identify the recording 118 in listings of available media content. The service module 132 may also provide a usage record to a billing and charging system 136 to enable accounting of use of the server 114, to enable charges to be assessed to the account associated with the user device 102 for the media content 104, to enable charges to be assessed to the account for services facilitated by the server 114, or combinations thereof.

The control module 134 may be activated by the processor 128 when the user of the user device 102 chooses to receive the notification of when the network 112 is able to provide the media content 104 or the recording 118 to the user device 102. The control module 134 may receive identification information for the user device 102 and information identifying the location of the media content 104 or the recording 118. For example, the information identifying the location of the media content 104 may indicate a location of the media content 104 at the content provider 106 when the user chooses not to record the media content 104 with the network recorder 116. In another example, the information identifying the location of the media content 104 may indicate a location of the recording 118 at the network recorder 116 when the user chooses to record the media content 104 at the network recorder 116. The control module 134 may periodically or occasionally check with the mobile network service center 110 to determine whether the network 112 is able to provide the media content 104 or the recording 118 to the user device 102. When the network 112 is able to provide the media content 104 or the recording 118 to the user device 102, the control module 134 may send the notification to the user device 102. The control module 134 may also provide a usage record to the billing and charging system 136 to enable accounting of use of the server 114, to enable charges to be assessed to the account associated with the user device 102 for services facilitated by the server 114, or both.

In a particular embodiment, sending the notification may include initiating setup of a connection between the user device 102 and a device that can provide the media content 104 to the user device 102 after the determination that the network 112 is able to provide the media content 104 to the user device 102 is made. For example, the server 114 may initiate setup of a connection via the mobile network service center 110 between the user device 102 and the content provider 106 when the user chooses not to record the media content 104 with the network recorder 116 and after the server 114 determines that the network 112 is able to send the media content 104 to the user device. Alternately, the server 114 may initiate setup of a connection via the mobile network service center 110 between the user device 102 and the network recorder 116 when the user chooses to record the media content 104 at the network recorder 116 after the determination that the network 112 is able to provide the recording 118 to the user device 102 is made.

In another particular embodiment, the notification may identify the location at which the user device 102 can access the requested media content after the determination that the network is able to send the requested media content to the user device 102 is made. The user device 102 may provide an alert to the user in response to the notification message, such as a vibration, an audio alert, an application specific pop-up, a call, a graphical user interface, another type of alert, or combinations thereof to notify the user of the user device 102 that the media content 104 or the recording 118 can be provided to the user device 102. The user device 102 may establish a connection to the location of the requested media content provided in the notification message when directed to by the user of the user device 102. For example, the user may activate a selectable option provided by a graphical user interface, or a selectable link to the location of the requested media content provided in an e-mail message, to cause the user device 102 to connect via the tower 108 and the mobile network service center 110 to the content provider 106 when the user chooses not to record the media content 104 with the network recorder 116. Alternately, the user may activate the selectable option of the graphical user interface, or the selectable link to the location of the requested media content in the e-mail message, to cause the user device 102 to connect via the tower 108 and the mobile network service center 110 to the network recorder 116 when the user chooses to record the media content 104 at the network recorder 116.

The network recorder 116 may be a module of the server 114 or may be an external network device. When the network recorder 116 is external to the server 114, the network recorder 116 may include a processor 138 and a memory 140 accessible by the processor 138. The memory 140 may include instructions executable by the processor 138. A portion of the instructions may be included in a record module 142. The processor 138 may receive a request to record the media content 104 from the server 114. The request may identify the media content 104 and the user device 102.

The processor 138 may activate the record module 142 to make the recording 118. The record module 142 may send information identifying the location of the recording 118 in the memory 140 (e.g., a uniform resource indicator) to the server 114. The record module 142 may provide a usage record to a billing and charging system 136 to enable accounting of use of the network recorder 116, to enable charges to be assessed to the account associated with the user device 102 for services provided by the network recorder 116, or both. The processor 138 may use an authentication, authorization, and accounting process to limit access to the recording 118 based on the identification of the user device 102 provided in the request.

The user device 102 may be a mobile device. The mobile device 102 may not include sufficient processing power, battery life, storage capacity, or combinations thereof to record some types of media content 104. Also, network connectivity and network resources may cause a request to access media content to be recorded to the user device 102 to be denied. The network recorder 116 may be advantageously used by the user to record the media content when the user is utilizing the user device 102.

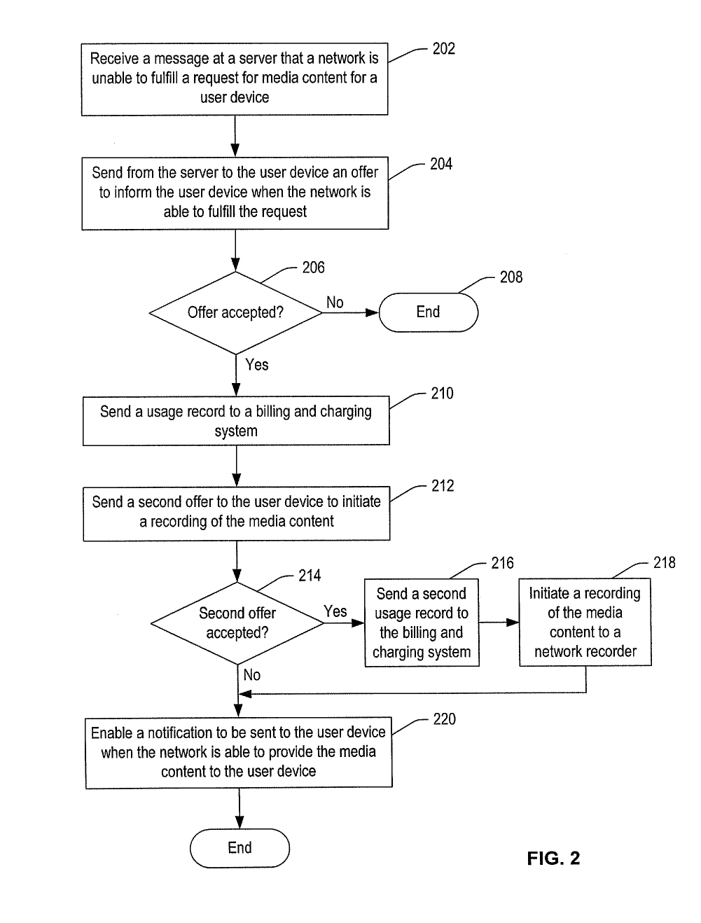

Referring to FIG. 2, a flow chart of a first particular embodiment of a method to provide availability notifications for denied content requests is shown. The method may be performed by a server (e.g., the server 114 depicted in FIG. 1). A user may request media content via a user device. The request may be routed to a mobile network service center that determines whether a network is able to fulfill the request. When the network is able to fulfill the request, the mobile network service center may facilitate providing the media content to the user device. When the network denies access to the media content, the mobile network service center may send a message to the server.

At 202, the message may be received at the server. The message may indicate that the network is not able to fulfill the request to provide the media content to the user device. The message may specifically identify the user device and the media content.

At 204, the server may send to the user device an offer to inform the user device when the network is able to fulfill the request. At 206, the server may determine whether the offer is accepted. Acceptance of the offer may be indicated by the server receiving an affirmative response to the offer from the user device. Denial of the offer may be indicated by the server receiving a negative response to the offer from the user device or by the passage of a predetermined amount of time after the offer is sent to the user device without receiving an acceptance from the user device. When the offer is denied, the method may end, at 208. When the offer is accepted, a usage record may be sent to a billing and charging system, at 210.

At 212, a second offer to initiate a recording of the media content may be sent to the user device. The second offer may be sent from the server. At 214, the server may determine whether the second offer is accepted. Acceptance of the second offer may be indicated by the server receiving an affirmative response to the second offer from the user device. Denial of the second offer may be indicated by the server receiving a negative response to the second offer or by the passage of a predetermined amount of time after the second offer is sent to the user device without receiving an acceptance from the user device. When the second offer is accepted, a second usage record may be sent to the billing and charging system, at 216. The second record may be sent from the server. A recording of the media content may be initiated, at 218. The server may include a network recorder that records the media content or the server may send an instruction to a separate network recorder that makes the recording.

The server may enable a notification to be sent to the user device when the network is able to provide the media content to the user device, at 220. In an embodiment, the server may enable the notification by executing instructions that determine when the network is able to provide the media content to the user device and by executing instructions that send the notification to the user device when the network is able to provide the media content to the user device. In another embodiment, the server may send a request for the notification to another network device (e.g., another server that is not shown). The other network device may determine when the network is able to provide the media content to the user device and send the notification to the user device when the network is able to provide the media content to the user device. The method may end, at 222.

When the second offer is rejected, the server may enable the notification to be sent to the user device when the network is able to provide the media content to the user device, at 220. The method may end at 222.

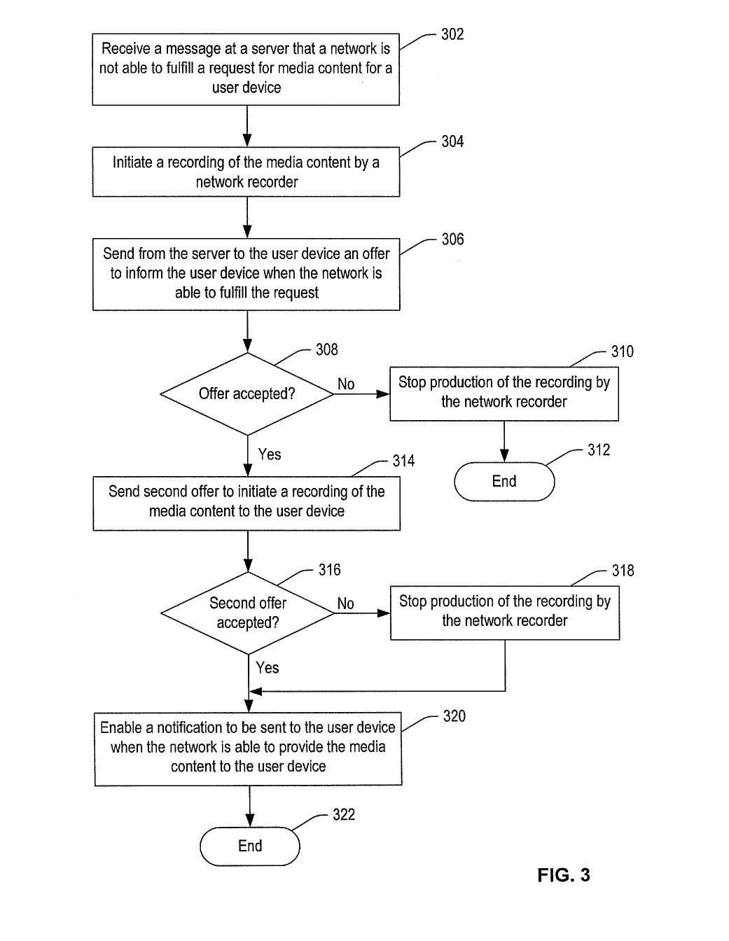

Referring to FIG. 3, a flow chart of a second particular embodiment of a method to provide availability notifications for denied content requests is shown. The method may be performed by a server (e.g., the server 114 depicted in FIG. 1). A user may request media content via a user device. The request may be routed to a mobile network service center that determines whether a network is able to fulfill the request. When the network is able to fulfill the request, the mobile network service center may facilitate providing the media content to the user device. When the network denies access to the media content, the mobile network service center may send a message to the server.

At 302, the message may be received at the server. The message may indicate that the network is not able to fulfill the request to provide the media content to the user device. The message may specifically identify the user device and the media content. The server may initiate a recording of the media content by a network recorder, at 304. The recording may be initiated in response to a request to record the media content sent by the server to the network recorder. In some embodiments, the network recorder may be a portion of the server.

At 306, the server may send to the user device an offer to inform the user device when the network is able to fulfill the request. At 308, the server may determine whether the offer is accepted. Acceptance of the offer may be indicated by the server receiving an affirmative response to the offer from the user device. Denial of the offer may be indicated by the server receiving a negative response to the offer from the user device or by the passage of a predetermined amount of time after the offer is sent to the user device without receiving an acceptance from the user device.

When the offer is denied, the server may stop production of the recoding by the network recorder, at 310. The production of the recording may be stopped by the server sending a signal to the network recorder to stop production of the recording. The contents of the recording may be deleted by the network recorder. Denial of the offer may be indicated by the server receiving a negative response from the user to the offer or by the passage of a predetermined amount of time after the offer is sent to the user device without receiving an acceptance from the user device. The method may end, at 312.

When the offer is accepted, a second offer to initiate a recording of the media content may be sent to the user device, at 314. The server may send the second offer to the user device. The server may also send a usage record to a billing and charging system.

At 316, the server may determine whether the second offer is accepted. Acceptance of the second offer may be indicated by the server receiving an affirmative response to the second offer from the user device. Denial of the second offer may be indicated by the server receiving a negative response from the user to the second offer or by the passage of a predetermined amount of time after the second offer is sent to the user device without receiving an acceptance from the user device.

When the second offer is denied, the server may stop production of the recording by the network recorder, at 318. The production of the recording may be stopped by the server sending a signal to the network recorder to stop production of the recording. The contents of the recording may be deleted by the network recorder. The server may enable a notification to be sent to the user device when the network is able to provide the media content to the user device, at 320. In an embodiment, the server may enable the notification by executing instructions that determine when the network is able to provide the media content to the user device and by executing instructions that send the notification to the user device when the network is able to provide the media content to the user device. In another embodiment, the server may send a request for the notification to another network device (e.g., another server). The other network device may determine when the network is able to provide the media content to the user device and send the notification to the user device when the network is able to provide the media content to the user device. The method may end, at 322.

When the second offer is accepted, a second usage record may be sent to the billing and charging system. Also, the server may enable the notification to be sent to the user device when the network is able to provide the media content to the user device, at 320. Initiating the recording when the message is received, at 304, may enable a user of the user device to view the media content substantially from the point when the user initiated a request to receive the media content via the user device when the recording is sent to the user device. The user may use controls of the user device to control playback of the recording. The method may end, at 322.

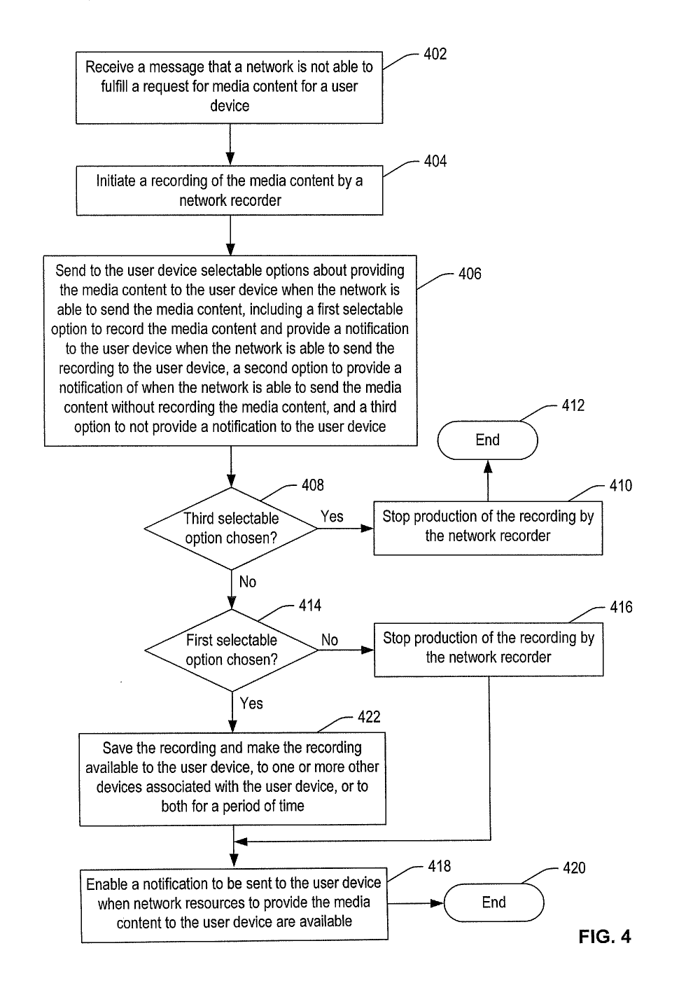

Referring to FIG. 4, a flow chart of a third particular embodiment of a method to provide availability notifications for denied content requests is shown. The method may be performed by a server (e.g., the server 114 depicted in FIG. 1). A user may request media content via a user device. The request may be routed to a mobile network service center that determines whether a network is able to fulfill the request. When the network is able to fulfill the request, the mobile network service center may facilitate providing the media content to the user device. When the network is not able to fulfill the request, the mobile network service center may send a message to the server.

At 402, the message may be received at the server. The message may indicate that the network is not able to fulfill the request to provide the media content to the user device. The message may specifically identify the user device and the media content. A recording of the media content may be initiated by a network recorder, at 404. The recording may be initiated in response to a request to record the media content sent to the network recorder by the server. In some embodiments, the network recorder may be a portion of the server.

At 406, selectable options related to providing the media content to the user device when the network is able to fulfill the request may be sent to the user device. In some embodiments, the user device may already have the selectable options as part of an application of the user device. The user device may display the selectable options to a user of the user device via a display of the user device (e.g., the display may show a graphical user interface with the selectable options). The selectable options may include a first selectable option to record the media content and provide a notification to the user device when the network is able to send the recording to the user device. The selectable options may include a second selectable option to provide a notification to the user device when the network is able to send the media device to the user device without recording the media content. The selectable options may also include a third selectable option to not provide a notification to the user device.

At 408, the server may determine whether the third selectable option was chosen. Selection of the third selectable option may be indicated by the server receiving a notice of the selection of the third selectable option from the user device or by passage of a predetermined amount of time without receiving a response from the user device. When the third selectable option was chosen, production of the recording by the network recorder may be stopped, at 410. The production of the recording may be stopped in response to a signal sent by the server to the network recorder to stop production of the recording. The contents of the recording may be deleted by the network recorder. The method may end, at 412.

When the third option was not chosen, the server may provide a usage record of the selected option to a billing and charging system. The server may determine whether the first selectable option was chosen, at 414. Acceptance of the first selectable option may be indicated by the server receiving a notice of the selection of the first selectable option from the user device.

When the first selectable option was not chosen, production of the recording by the network recorder may be stopped, at 416. Production of the recording may be stopped in response to a signal sent by the server to the network recorder to stop production of the recording. The contents of the recording may be deleted by the network recorder. Also, the server may enable a notification to be sent to the user device when the network is able to provide the media content to the user device, at 418. In an embodiment, the server may enable the notification by executing instructions that determine when the network is able to provide the media content to the user device and by executing instructions that send the notification to the user device when the network resources to provide the media content to the user device are available. In another embodiment, the server may send a request for the notification to another network device (e.g., another server). The other network device may determine when the network is able to provide the media content to the user device and send the notification to the user device when the network is able to provide the media content to the user device. The method may end, at 420.

When the first selectable option was chosen, at 414, the recording may be saved, at 422. The recording may be saved in response to the server sending a request to the network recorder to save the recording. The recording may continue to be made until an end of the media content is reached. In some embodiments, the recording may be stopped before the end of the media content when the user of the user device starts to receive the recording and issues a command via the user device to end receiving the recording before the network device has completed making the recording of the media content. When the user requests to stop receiving the recording before the network recorder has completed making the recording, a selectable option may be sent to the user to stop the making the recording of the media content or to continue making the recording of the media content. When the user selects to stop making the recording, the network recorder stop making the recording and may delete the recording of the media content.

The request to save the recording may initiate an instruction to make the recording available to the user device, to one or more other devices associated with the user device, or to both. The one or more other devices associated with the user device may include one or more devices (e.g., a set top box device, a tablet computer, a laptop computer, a mobile communication device, or other devices) that are linked to an account associated with the user device. The recording may be saved for a predetermined period of time (e.g., 5 days, one week, 2 weeks, one month, or other time frame). After expiration of the predetermined period of time, the network recorder or a server (e.g., the server 114 depicted in FIG. 1) may delete the recording. When the user device or another device associated with the user device tries to access the recording, the network recorder may implement an authentication, authorization, and accounting process to determine that the device seeking access to the recording is authorized to access the recording and to generate an accounting record of the access.

The server may enable the notification to be sent to the user device when the network is able to provide the media content (i.e., as the recording) to the user device, at 418. The method may end, at 420.

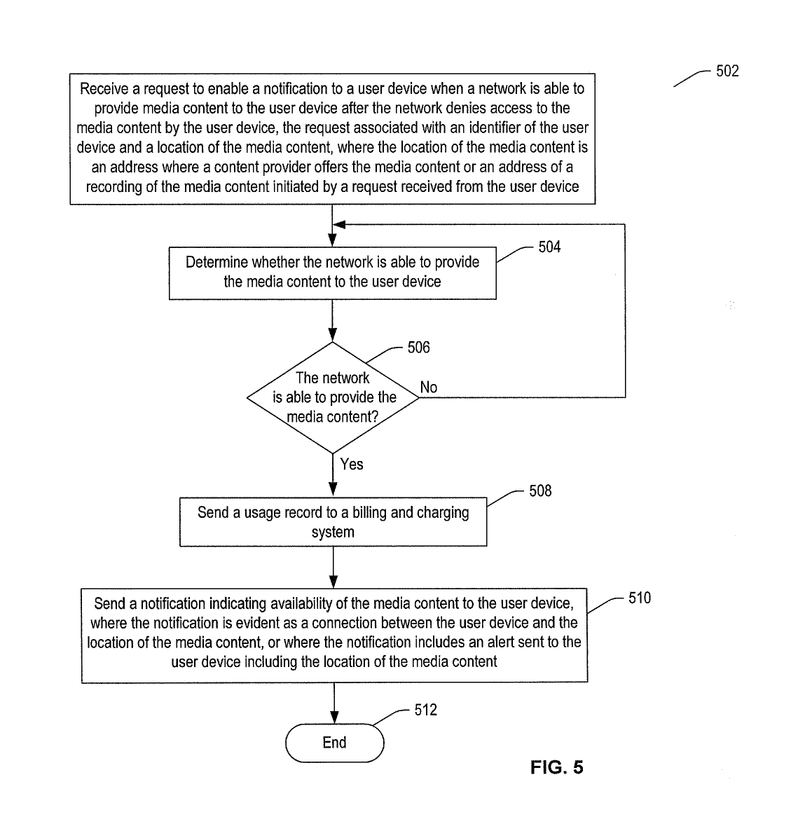

Referring to FIG. 5, a flow chart of a fourth particular embodiment of a method to provide availability notifications for denied content requests is shown. At 502, a request to enable a notification to a user device when a network is able to provide media content to the user device may be received after the network denies access to the media content by the user device. The request may be received at a server (e.g., the server 114 depicted in FIG. 1), from a user device, or from another network device (e.g., another server, not shown). The request may be associated with an identifier of the user device and a location of the media content. The location of the media content may be an address (e.g., a uniform resource identifier) where a content provider offers the media content or an address (e.g., a uniform resource identifier) of a recording of the media content initiated by a request received from the user device.

At 504, the server may determine whether the network is able to provide the media content to the user device. For example, the server may periodically attempt to establish a connection to the media content via the mobile network service center as if the server where a user device. When the mobile network service center allows the connection to the media content, the network is able to provide the media content to the user device. When the mobile network service center denies the connection to the media content, the network is not able to provide the media content to the user device. When the network is not able to provide the media content, at 506, the server may repeat the determination, at 504, until the network is able to provide the media content to the user device.

When the network is able to provide the media content, at 506, the server may send a usage record to a billing and charging system, at 508. The usage record may be used to charge an account associated with the user device for a service, may be used to track usage of the service, or both.

At 510, a notification indicating availability of the media content to the user device may be sent from the server to the user device. In some embodiments, the notification is evident to a user of the user device as a connection established by the server between the user device and the location of the media content. For example, the server may initiate setup of a connection between the media content and the user device by a mobile network service center. When the connection is established, the media content is provided to the user device. In some embodiments, the notification includes an alert sent to the user device including information identifying the location of the media content. The information identifying the location of the media content may be presented in the notification as a selectable link that allows the user to receive the media content when the user activates the selectable link. The user device may vibrate, present an audio signal (e.g., an alarm), present a message, present a graphical user interface, or combinations thereof in response to receiving the notification. The user of the user device may be presented with an option to connect to the media content by choosing the selectable link or by choosing a button or other graphic that instructs the user device to connect to the location of the media content. The method may end, at 512.

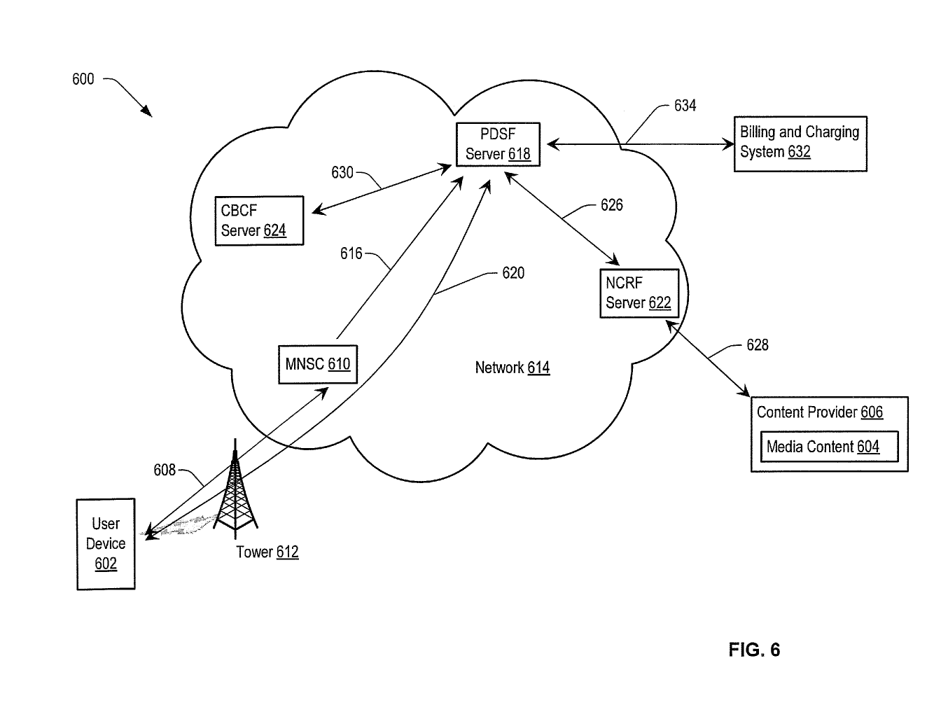

Referring to FIG. 6, a block diagram of a second embodiment of a system 600 to provide availability notifications for denied content requests is shown. A user of a user device 602 may request media content 604 from a content provider 606 via the user device 602. The user device 602 may be a mobile communication device. As indicated by a communication 608, an initial session setup is established between the user device 602 and a mobile network service center (MNSC) 610 of a network 614 via a tower 612. When the MNSC 610 determines that the network 614 is not able to provide the media content 604 to the user device 602, the MNSC 610 may send a message 616 to a post-dial service function (PDSF) server 618. The message 616 may identify the user device 602 and the media content 604. The PDSF server 618 may include a service module, such as the service module 132 of the server 114 shown in FIG. 1.

The PDSF server 618 may establish a communication 620 with the user device 602 via the tower 612. The communication 620 may be used by the PDSF server 618 to determine whether the user of the user device 602 wants to receive a notification of when the network 614 is able to provide the media content 604 to the user device 602 and whether the user wants to have a network recorder record the media content 604 for the user. The communication 620 may include a response to the PDSF server 618 that indicates that the user wants the user device 602 to be notified when the network 614 is able to provide the media content to the user device 602 and that the user wants the media content 604 to be recorded (e.g., by a network recorder).

In response to the communication 620 indicating to the PDSF server 618 that the user wants to be notified when the network 614 is able to provide the media content 604 to the user device 602 and that the user wants the media content 604 to be recorded, the PDSF server 618 may contact a network content recorder function (NCRF) server 622 and a callback control function (CBCF) server 624. The NCRF server 622 may include a network recorder, such as the network recorder 116 depicted in FIG. 1. The CBCF server 624 may include a control module, such as the control module 134 of the server 114 depicted in FIG. 1.

The PDSF server 618 may contact the NCRF server 622 via a communication 626. The communication 626 from the PDSF server 618 may provide information to the NCRF server 622 (e.g., identification of the media content 604 and identification of the user device 602) and may cause the NCRF server 622 to initiate a recording of the media content 604. To initiate the recording, the NCRF server 622 may communicate via a communication 628 with the content provider 606. The content provider 606 may provide the media content 604 to the NCRF server 622 via the communication 628. After initiation of the recording, the NCRF server 622 may use the communication 626 to provide the PDSF server 618 with a network resource identifier that enables retrieval of the recording from the NCRF server 622.

The PDSF server 618 may contact the CBCF server 624 via a communication 630. The communication 630 may be a request from the PDSF server 618 for the CBCF server 624 to provide the notification to the user device 602 when the network 614 is able to provide access to the media content 604 (e.g., in the form of the recording of the media content 604 from the NCRF server 622) to the user device 602. The CBCF server 624 enters the request in a job queue, along with an identifier of the user device 602 and the network resource identifier of the recording. The CBCF server 624 begins checking the ability of the network 614 to provide the recording of the media content 604 to the user device 602.

The PDSF server 618 may also contact a billing and charging system 632 via a communication 634. The communication 634 may be used to provide a usage record associated with the user device 602. The usage record may be used to assess charges to an account associated with the user device 602 for use of the system 600.

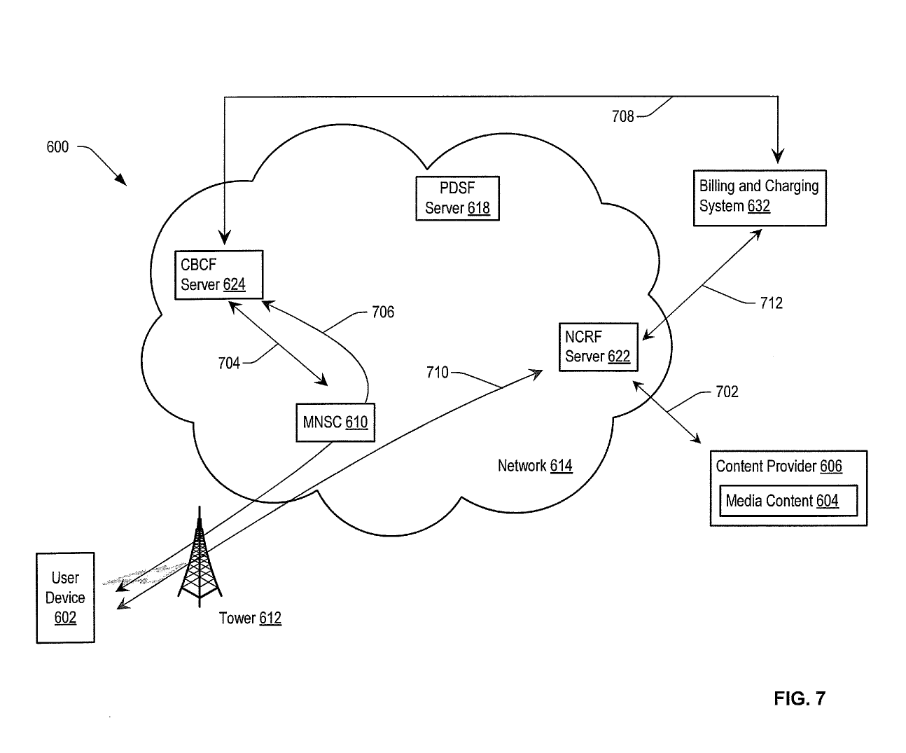

Referring to FIG. 7, a continuation of the second embodiment of the system 600 to provide network availability notification for denied content requests is shown. FIG. 7 depicts operation of the CBCF server 624 and other devices to provide a requested notification and a requested recording of media content 604 to the user device 602 when the user device 602 was denied access to the media content 604 by the MNSC 610. The NCRF server 622 records the media content 604 via a communication 702 between the content provider 606 and the NCRF server 622 based on a request received from the user device 602.

The CBCF server 624 contacts the MNSC 610 via a communication 704 to check whether the network 614 is able to provide the recording of the media content 604 to the user device 602. When the MNSC 610 indicates that the network 614 is not able to provide the recording of the media content 604 to the user device 602, the CBCF server 624 waits a period of time and then contacts the MNSC 610 again via another communication 704 to check whether the network 614 is able to provide the recording of the media content 604 to the user device 602. The CBCF server 624 may continue to check the MNSC 610 until the MNSC 610 indicates that the network 614 is able to provide the recording of the media content 604 to the user device. When the MNSC 610 indicates that the network 614 is able to provide the recording of the media content 604 to the user device 602, the CBCF server 624 initiates a callback 706 to the user device 602 via the MNSC 610 and the tower 612. The CBCF server 624 may send a usage record to the billing and charging system 632 via a communication 708. The usage record may be used to assess charges to the account associated with the user device 602 for use of the system 600.

The callback 706 may be used to establish a communication 710 via the tower 612 between the user device 602 and the NCRF server 622. The communication 710 may be used to send the recording of the media content 604 made by the NCRF server 622 to the user device 602. The NCRF server 622 may send a second usage record to the billing and charging system 632 via a communication 712. The second usage record may be used to assess charges to the account associated with the user device 602 for use of the system 600.

Various embodiments disclosed herein enable a user device to receive a notification when a network resources is able to provide requested media content to the user device after the requested media content is initially denied to the user device. Providing the option to receive a notification of when the network is able to provide the media content to the user may reduce negative feelings and complaints from users that are denied access to requested media content.

Various embodiments disclosed herein also describe providing a user of a mobile user device with an option to record requested media content to a network recorder when access to the requested media content is denied. Even should storage, battery, and computing power issues be resolved to allow mobile user devices to record the many types of available media content, radio network connectivity and resources may remain a barrier for having mobile user devices record media content. Initiating recording of media content to a network device from a mobile user device enables the user of the user device to record the media content that might otherwise be irretrievable.

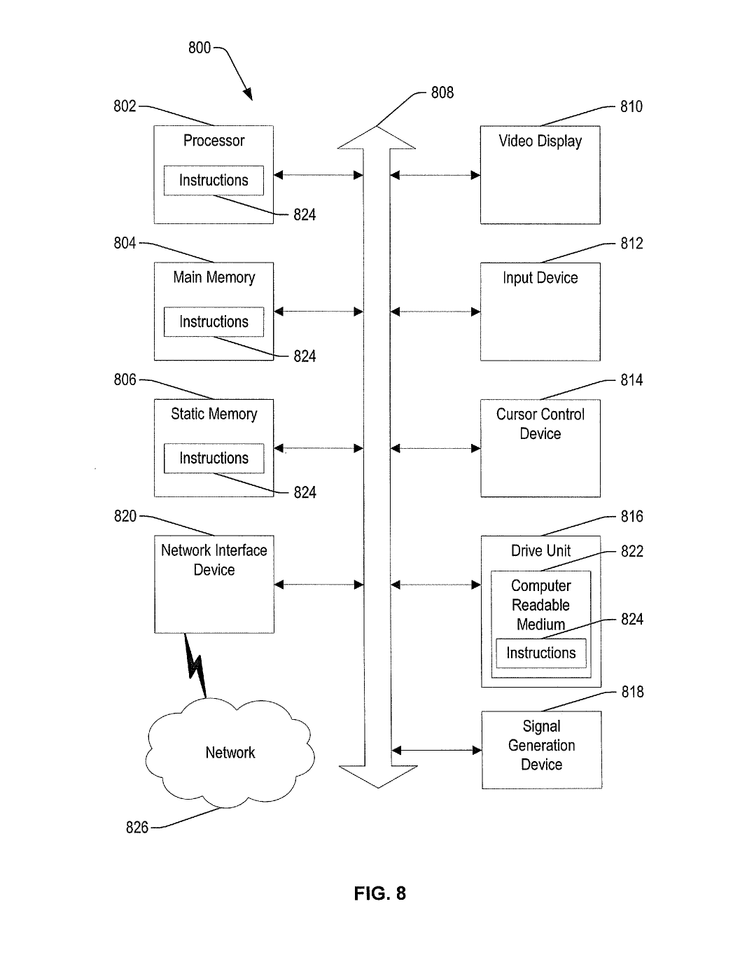

Referring to FIG. 8, an illustrative embodiment of a general computer system is shown and is designated 800. The computer system 800 may include a set of instructions that can be executed to cause the computer system 800 to perform any one or more of the methods or computer based functions disclosed herein. The computer system 800 may operate as a standalone device or may be connected, e.g., using a network, to other computer systems or peripheral devices. For example, the computer system 800 may include or be included within any one or more of the user device 102, mobile network service center 110, the server 114, the network recorder 116, the computer system 120, and the media device 122, described with reference to FIG. 1.

In a networked deployment, the computer system 800 may operate in the capacity of a server or as a client user computer in a server-client user network environment, or as a peer computer system in a peer-to-peer (or distributed) network environment. The computer system 800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a web appliance, or any other machine capable of executing a set of instructions (sequential or otherwise) that specify actions to be taken by that machine. In a particular embodiment, the computer system 800 may be implemented using electronic devices that provide video, audio, or data communication. Further, while a single computer system 800 is illustrated, the term “system” shall also be taken to include any collection of systems or sub-systems that individually or jointly execute a set, or multiple sets, of instructions to perforin one or more computer functions.

As illustrated in FIG. 8, the computer system 800 may include a processor 802, e.g., a central processing unit (CPU), a graphics processing unit (GPU), or both. Moreover, the computer system 800 may include a main memory 804 and a static memory 806, which can communicate with each other via a bus 808. As shown, the computer system 800 may further include a video display unit 810, such as a liquid crystal display (LCD), a projection television system, a flat panel display, or a solid state display. Additionally, the computer system 800 may include an input device 812, such as a keyboard, and a cursor control device 814, such as a mouse. The computer system 800 may also include a disk drive unit 816, a signal generation device 818, such as a speaker or remote control, and a network interface device 820. Some computer systems 800 may not include an input device (e.g., a server may not include an input device).

In a particular embodiment, as depicted in FIG. 8, the disk drive unit 816 may include a tangible computer-readable storage medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include tangible computer-readable storage media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by the computer system 800. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a tangible computer-readable storage medium that stores instructions 824 or that receives, stores and executes instructions 824, so that a device connected to a network 826 may communicate voice, video or data over the network 826. Further, the instructions 824 may be transmitted or received over the network 826 via the network interface device 820.

While the tangible computer-readable storage medium is shown to be a single medium, the term “tangible computer-readable medium” includes a single medium or multiple media, such as a centralized or distributed database, and/or associated caches and servers that store one or more sets of instructions. The term “tangible computer-readable medium” shall also include any medium that is capable of storing instructions for execution by a processor or that cause a computer system to perform any one or more of the methods or operations disclosed herein.

In a particular non-limiting, exemplary embodiment, the tangible computer-readable storage medium may include a solid-state memory such as a memory card or other package that houses one or more non-volatile read-only memories. Further, the tangible computer-readable storage medium may be a random access memory or other volatile re-writable memory. Additionally, the tangible computer-readable storage medium may include a magneto-optical or optical medium, such as a disk or tapes or other storage device. Accordingly, the disclosure is considered to include any one or more of a tangible computer-readable storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP, TREE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving a message at a server, the message indicating that a network is unable to fulfill a request for media content for a user device; and
sending, from the server to the user device, an offer to inform the user device when the network is able to fulfill the request.

2. The method of claim 1, further comprising:
determining that the network is able to provide the media content to the user after receiving acceptance of the offer; and
sending a notification to the user device of availability of the media content in response to determining that the network resources is able to provide the media content to the user device.

3. The method of claim 2, wherein sending the notification comprises initiating setup of a connection between the user device and the media content.

4. The method of claim 2, wherein the notification includes a selectable link to the media content and wherein the notification enables the user device to alert a user to the availability of the media content by at least one of a vibration, an audio signal, a text message, and presentation of a graphical user interface.

5. The method of claim 1, further comprising:
initiating a recording of the media content at a network device in response to receiving the message before receiving a response to the offer; and
stopping the recording of the media content at the network device in response to at least one of receipt of a denial of the offer and receipt of a denial of a second offer sent to the user device to record the media content.

6. The method of claim 1, further comprising sending to the user device a second offer to record the media content in response to receiving acceptance of the offer.

7. The method of claim 6, further comprising initiating a recording of the media content at a network device in response to acceptance of the second offer.

8. The method of claim 7, further comprising:
determining that the network is able to provide the media content to the user device; and
sending a notification to the user device of availability of the media content in response to determining that the network is able to provide the media content to the user device, wherein the notification includes an identification of a location of the recording.

9. The method of claim 7, further comprising saving the recording for a period of time, wherein the recording is accessible by the user device during the period of time.

10. The method of claim 9, wherein access to the recording is available to one or more other devices associated with the user device during the period of time.

11. The method of claim 1, further comprising sending a usage record to a billing and charging system when acceptance of the offer is received.

12. A system comprising:
a processor;
a memory accessible to the processor, the memory comprising instructions executable by the processor to:
receive a request to send a notification to a user device when a network is unable to provide media content to the user device;
determine whether the network is able to provide the media content to the user device; and
send a notification indicating availability of the media content to the user device in response to a determination by the processor that the network is able to provide the media content to the user device.

13. The system of claim 12, wherein the notification includes a link to establish a connection between the user device and a location of the media content to be provided to the user device.

14. The system of claim 12, wherein the notification includes an alert, the alert including an address of a location of the media content.

15. The system of claim 12, wherein the notification includes an address of a recording of the media content, the recording made in response to a particular request received from the user device to record the media content.

16. The system of claim 12, wherein the memory further comprises instructions executable by the processor to send a usage record to a billing and charging system.

17. A tangible computer-readable storage medium comprising instructions, that when executed by a processor, cause the processor to:
receive a request for media content from a user device;
determine that a network is unable to provide the media content to the user device; and
send selectable options to the user device, wherein the selectable options include a first selectable option to notify the user device when the network is able to fulfill the request.

18. The tangible computer-readable storage medium of claim 17, wherein the selectable options include a second selectable option to record the media content to a network recorder and to receive notification of when the network resources become available to fulfill the request.

19. The tangible computer-readable storage medium of claim 17, wherein the selectable options include a second selectable option to record the media content as a recording and to make the recording available to the user device without providing a call back to the user device when the network resources become available to fulfill the request.

20. The tangible computer-readable storage medium of claim 19, wherein the recording is made available to one or more other devices associated with the user device.
